(19) United States
(12) Patent Application Publication
(10) Pub. No.: US 2009/0314241 A1
(43) Pub. Date: Dec. 24, 2009

(54) AIR INDUCTION HOUSING HAVING AN AUXILIARY TUNING VOLUME FOR ENHANCING ATTENUATION AND BROADENING THE BANDWIDTH OF A PRIMARY SOUND ATTENUATOR

(75) Inventors: Julie A. Koss, Macomb, MI (US); Bernard J. Vascotto, Ray, MI (US); Scott K. Furey, Ypsilanti, MI (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/141,120

(22) Filed: Jun. 18, 2008

(51) Int. Cl. F02M 35/10; G10K 11/00

(52) U.S. Cl. 123/184.53; 181/198

(57) ABSTRACT

An air induction housing as for example for a motor vehicle having an auxiliary tuning volume which provides an enhancement of the attenuation and a broadening of the bandwidth of attenuation of any primary attenuator of the air induction housing, yet with a minimal expense, complexity and packaging volume, and without adversely affecting the air flow path. The auxiliary tuning volume is characterized by an intermediate wall having a tuning slot, wherein the wall separates a tuning chamber of the auxiliary tuning volume from the main airflow passage of the housing.

### TECHNICAL FIELD

The present invention relates to air induction housings as for example used in the automotive arts for air intake and air filtration for supplying intake air to a normally aspirated or charged internal combustion engines, hydrogen fuel cells, etc. More particularly, the present invention relates to an air induction housing having an auxiliary tuning volume which provides attenuation enhancement and bandwidth broadening for a primary attenuator connected to the air induction housing.

### BACKGROUND OF THE INVENTION

Internal combustion engines and hydrogen fuel cells rely upon an ample source of clean air for proper combustion therewithin of the oxygen in the air mixed with a supplied fuel (internal combustion) or the oxygen required for the hydrogen fuel cell chemical reaction. In this regard, an air induction housing is provided which is connected with the intake manifold/air supply of the engine/fuel cell, wherein the air induction housing has at least one air induction opening for the drawing-in of air, and further has a filter disposed thereinside such that the drawn-in air must pass therethrough and thereby be cleaned prior to exiting the air induction housing on its way to the intake manifold/fuel cell turbine inlet.

Problematically, a consequence of the combustion of the fuel-air mixture within the internal combustion engine or the high rpm turbine inlet of the hydrogen fuel cell is the generation of noise (i.e., unwanted sound). A component of this noise is intake noise which travels through the intake manifold or from the fuel cell turnbine inlet, into the air induction housing, and then radiates out from the at least one air induction opening. The intake noise varies in amplitude across a wide frequency spectrum dependent upon the operational characteristics of the internal combustion engine or the design/rpm range of the fuel cell turbine inlet, and to the extent that it is audible to passengers of the motor vehicle and persons exposed to the sound during a passby event, it is undesirable.

As shown at FIG. 1, a solution to minimize the audibility of intake noise is to equip an air induction housing 10 with an externally disposed Helmholtz attenuator 11 which is composed of a Helmholtz chamber (also referred to as a resonator) 12 and a snorkel 14 externally connected to the air induction housing. The air induction housing 10 has upper and lower housing components 16, 18 which are sealed with respect to each other, and are also selectively separable for servicing a filter media (not shown) which is disposed thereinside. An induction duct 20 is connected to the induction housing and defines an air induction opening 22 for providing a source of intake air to the air induction housing at one side of the filtration media, as for example by being interfaced with the lower housing component 18. An intake manifold duct 24 is adapted for connecting with the intake manifold of the internal combustion engine or the turbine inlet of the hydrogen fuel cell and is disposed so as to direct the intake air at the other side of the filtration media out of the air induction housing 10, as for example via the upper housing component 16.

One end of the snorkel 14 is connected to the induction duct 20 adjacent the air intake opening 22. The other end of the snorkel 14 is connected to the Helmholtz chamber 12. Each end of the snorkel 14 is open so that intake noise may travel between the induction duct 20 and the Halmholtz chamber 12. The Helmholtz chamber 12 is shaped and the snorkel 14 configured (as for example as two snorkel tubes 14a, 14b) such that the intake noise passing through the induction duct toward the air intake opening in part passes into the resonator and then back into the induction duct so as to attenuate the intake noise by frequency interference such that the audibility of the intake noise exiting the air intake opening is minimized.

While the prior art solution to provide attenuation of intake noise does work, it does so by requiring the inclusion of an externally disposed snorkel and resonator combination which adds expense, installation complexity and packaging volume accommodation.

Accordingly, what is needed in the art is to somehow provide an enhancement of the attenuation and broadening of the bandwidth of attenuation of any primary attenuator of the air induction housing, yet with a minimized expense, complexity and packaging volume, and without adversely affecting the air flow path.

### SUMMARY OF THE INVENTION

The present invention is an air induction housing as used for example, but not limitation, supplying intake air to normally aspirated or charged internal combustion engines, hydrogen fuel cells, etc., wherein the air intake housing has an auxiliary tuning volume with a specific sized tuning slot opening for a tuning chamber which operates in conjunction with a primary attenuator of the air intake housing, and wherein the auxiliary tuning volume enhances the attenuation and broadens the bandwidth of attenuation of any primary attenuator of the air induction housing, yet with a minimal expense, complexity and packaging volume, and without adversely affecting the air flow path.

The air induction housing according to the present invention includes a main airflow passage and further includes an auxiliary tuning volume composed of a tuning chamber, preferably disposed at an upper portion of the air intake housing, which communicates with the main airflow passage. The tuning chamber is, in part, defined by an intermediate wall, wherein the tuning chamber has a predetermined volume and shape. A tuning slot is provided in the intermediate wall which communicates between the tuning chamber and the main airflow passage, wherein the tuning slot has a length (which exceeds its width), wherein the length is oriented in transverse relation to the direction of airflow (the airflow path) through the main airflow passage.

The auxiliary tuning volume according to the present invention provides enhancement of the attenuation of any primary sound attenuator, while additionally broadening the bandwidth (frequency spectrum) of the sound attenuation of the primary sound attenuator.

A significant aspect of the present invention is that the intake noise attenuation enahncement and bandwidth broadening are accomplished inherently at the air induction housing, with a minimization of packaging volume of the housing and of the primary sound attenuator, and minimal weight, yet is configurationally simplistic and does not adversely affect the airflow path of the intake air through the main airflow passage.

Accordingly, it is an object of the present invention to provide an air induction housing having an integrated auxiliary tuning volume which provides both enhancement of sound attenuation and broadening of the bandwidth of the sound attenuation for any primary sound attenuator of the air intake housing, wherein the tuning chamber thereof has a tuning slot opening into the main airflow passage and oriented transverse to the airflow through the main airflow passage of the housing.

This and additional objects, features and advantages of the present invention will become clearer from the following specification of a preferred embodiment.

### BRIEF DESCRIPTION OF THE DRAWINGS

FIG. 1 is a perspective view of a prior art air induction housing including a Helmholtz attenuator in the form of an external snorkel and resonator combination for attenuating intake noise.

FIG. 2 is a perspective plan view of an air intake housing having a primary sound attenuator and an auxiliary tuning volume according to the present invention.

FIG. 3 is a perspective sectional view, seen along line 3-3 of FIG. 2.

FIG. 3A is a perspective view as in FIG. 3, wherein, in contrast with FIG. 3, the tuning chamber sidewalls are now integrated with the air induction housing.

FIG. 4 is a perspective, detail, partly sectional view of the air induction housing of FIG. 2, wherein the tuning chamber sidewalls of the auxiliary tuning volume are sectioned.

FIG. 5 is a perspective sectional view, seen along line 5-5 of FIG. 2.

FIG. 6 is a graph of frequency of sound versus sound level, wherein a first plot is for an air intake housing as in FIG. 2, having a primary sound attenuator and the auxiliary tuning volume, and a second plot is for the air intake housing as generally in FIG. 2 but with primary sound attenuator alone.

FIG. 7 is a graph of frequency of sound versus sound level, wherein a first plot is for an air intake housing as in FIG. 2, having a primary sound attenuator and the auxiliary tuning volume, and a second plot is an exemplar baseline for the air induction housing.

FIG. 8 is a perspective view of an air induction housing generally similar to that of FIG. 1, but now including an auxiliary tuning volume according to the present invention.

FIG. 9 is a bottom perspective view of the upper housing component of an air induction housing of FIG. 8, showing the auxiliary tuning volume of the present invention.

FIG. 10 is a sectional view seen along line 10-10 of FIG. 9.

FIG. 11 is a graph of engine RPM versus sound level, wherein a first plot is for an air induction housing as in FIG. 1 having a snorkel and Helmholtz chamber alone, a second plot is for the air intake housing as in FIG. 8 having the auxiliary tuning volume, and a third plot is for a predetermined acceptable quietness level.

FIG. 12 is a flow chart exemplifying an optimization algorithm for tuning the auxiliary tuning volume according to the present invention.

### DESCRIPTION OF THE PREFERRED EMBODIMENT

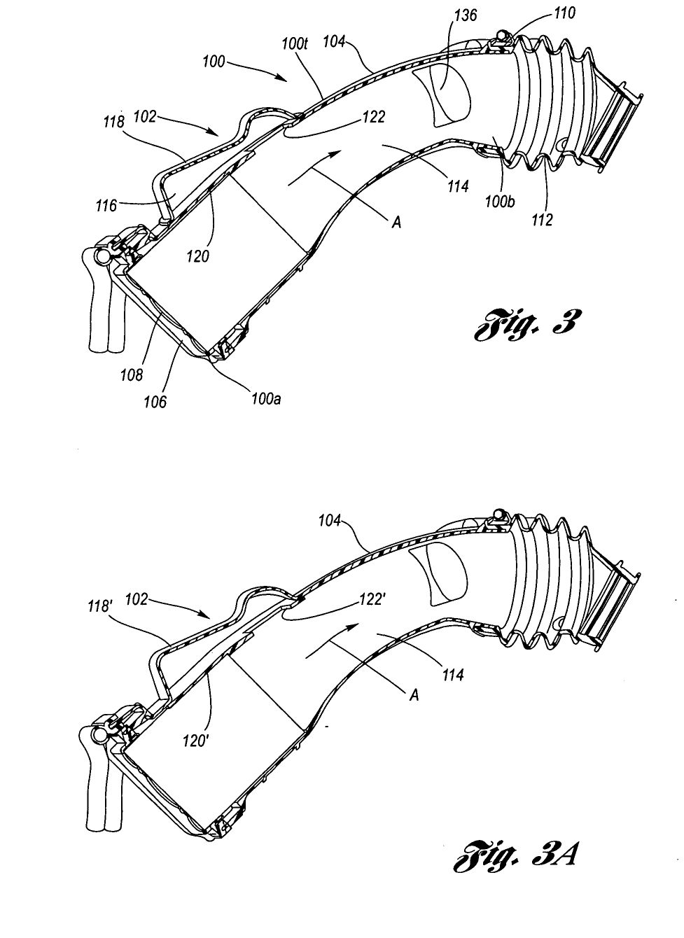

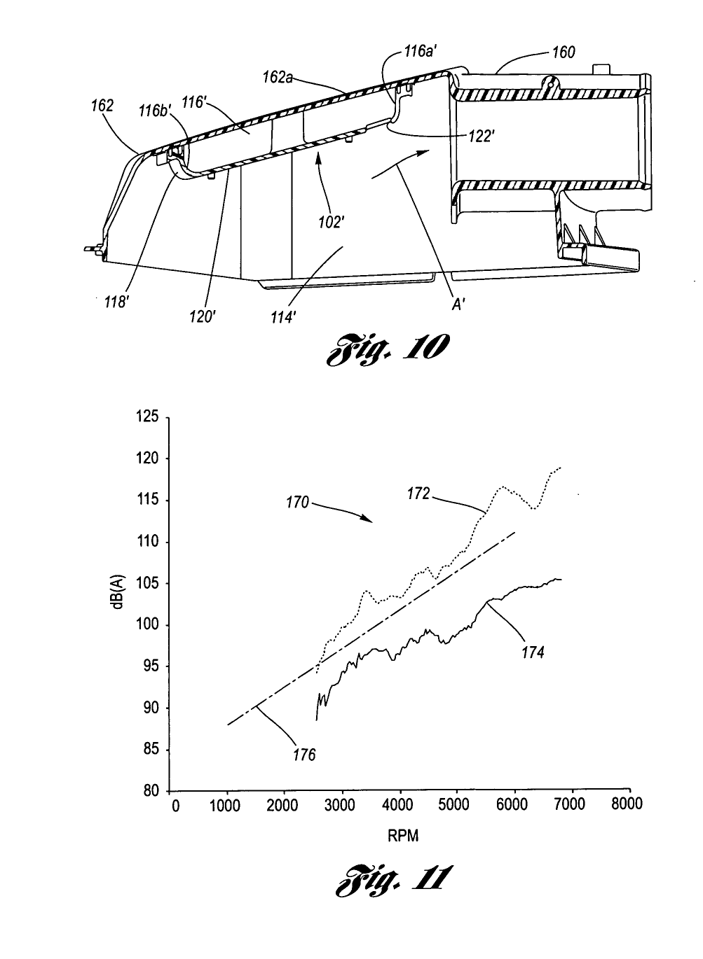

Referring now to the Drawing, FIGS. 2 through 12 depict various aspects of an air induction housing having an auxiliary tuning volume according to the present invention.

With regard to intake noise attenuation provided by a (sound) attenuation chamber, the attenuation may operate on the basis of a Helmholtz attenuator (resonator), as for example discussed in U.S. Pat. No. 5,979,598, wherein the resonant frequency thereof is given by (see for example http://en.wikipedia.org/wiki/Helmholtz_resonator):

$${ω}_{H} = \sqrt{γ \frac{ {A}^{2}}{m} \frac{{P}_{0}}{{V}_{0}}} \qquad ( 1 )$$

where γ is the adiabatic index, A is the cross-sectional area of an aperture (or neck in a classic Helmholtz resonator), m is the mass of the gas in the cavity, P₀ is the static pressure in the cavity, V₀ is the static volume of the cavity.

Referring firstly to FIGS. 2 through 5, a first exemplary configuration of an air induction housing 100 with an auxiliary tuning volume 102 according to the present invention is depicted. It is to be understood that the detailed description and accompanying drawing are merely exemplary, and that the present invention has wide application to air induction housings generally as used for example, but not limitation, supplying intake air to normally aspirated or charged internal combustion engines, hydrogen fuel cells, etc.

The air induction housing 100 has a generally unified construction defined by a housing sidewall 104, composed of, for example, a plastic material. At an upstream housing end 100a of the air induction housing 100 is an intake opening 106 whereat is situated an air filter 108. At a downstream housing end 100b of the air induction housing 100 is a neck 110 which connects to a ducting 112 and eventually interconnects to intake components of the motor vehicle engine. The shape of the housing sidewall 104 is determined to provide an adequate supply of airflow A to the engine, wherein in this respect the shape and size of main airflow passage 114 takes into account the rate of airflow and airflow turbulence. The shape of the housing sidewall 104 also must fit into whatever packaging constraint may subtend in the engine compartment, which often favors smaller, compact shapes. As used herein, the terms “upstream” and “downstream” are defined by the direction of airflow A through the main airflow passage 114.

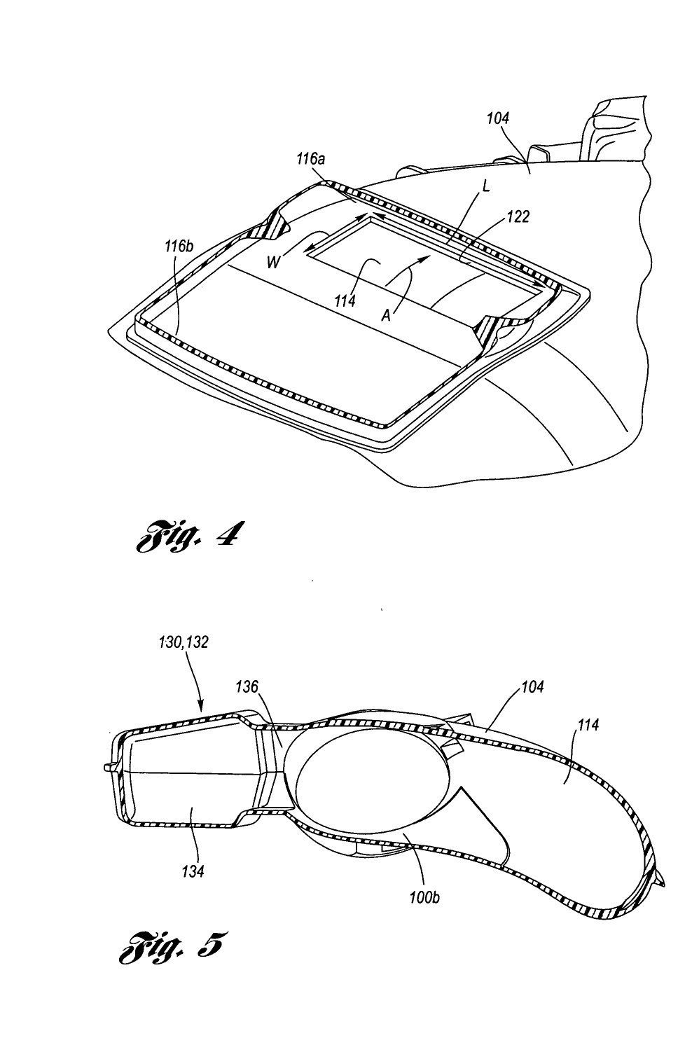

The auxiliary tuning volume 102 according to the present invention is mounted, by preferred example, at a top portion 100t of the air induction housing 100. The auxiliary tuning volume 102 is in the form of a tuning chamber 116, defined by a chamber sidewall 118 and an intermediate wall 120 which separates the tuning chamber from the main airflow passage 114. A tuning slot 122 is formed in the intermediate wall 120 which permits air borne sound communication between the tuning chamber 116 and the main airflow passage 114. The tuning slot 122 has a longest axis along its length L (the width being shorter), wherein the length is oriented transversely in relation to the direction of the airflow A through the main airflow passage 114 (see FIG. 4). In this regard, it is preferred for the tuning slot to be located at a downstream end 116a of the tuning chamber 116, whereby sound entering thereinto through the tuning slot 112 is caused to travel toward the upstream end 116b of the tuning chamber (the end closest to the air intake opening 106).

Comparing FIG. 3 with FIG. 3A, different modalities for attachment of the auxiliary tuning chamber 116 are depicted. At FIG. 3, the intermediate wall 120 is integral with the housing sidewall 104, wherein the chamber sidewall 118 is attached, as for example by vibration welding, to the housing sidewall. Whereas, at FIG. 3A, the chamber sidewall 118′ is integral with the housing sidewall 104′, wherein the intermediate wall 120′ is attached, as for example by vibration welding, to the housing sidewall.

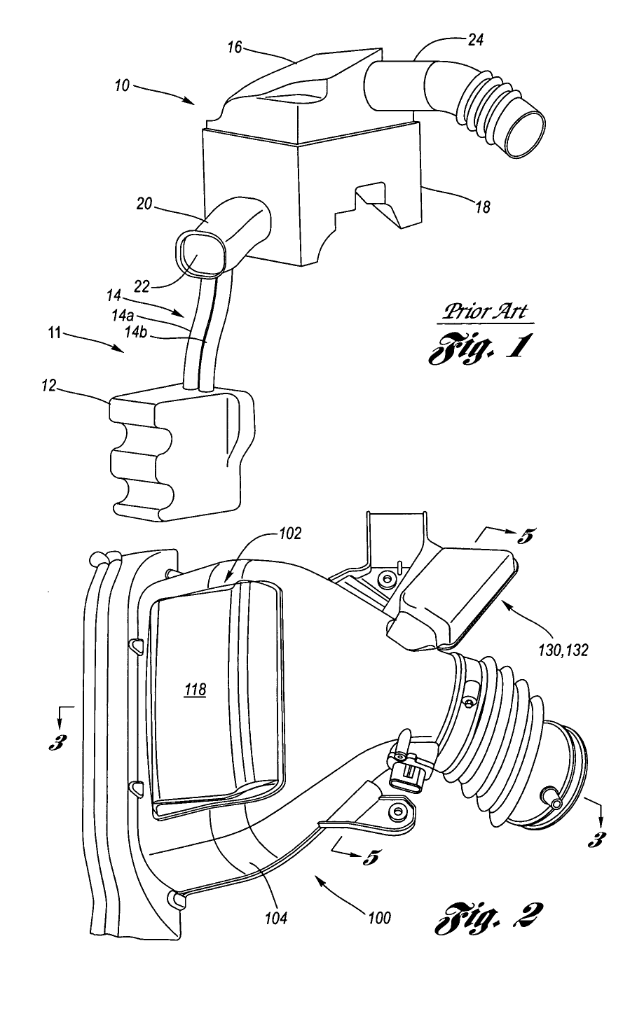

The auxiliary tuning volume 102 according to the present invention operates in conjunction with any primary sound attenuator 130 of the air intake housing 100 so as to enhance the sound attenuation and broaden the sound attenuation bandwidth thereof (the term “primary sound attenuator” refers to any number of sound attenuators that are being used). As shown at FIGS. 2, 3 and 5, the primary sound attenuator 130 is in the form of a primary Helmholtz attenuator 132, which is, for example, in the form of a generally box-shaped primary Helmholtz chamber 134 which has a primary opening 136 near the downsteam housing end 100b. Attenuators similar to the primary Helmholtz attenuator 132 are generally known in the prior art, as for example the Helmholtz attenuator 11 of FIG. 1.

As discussed further hereinbelow with respect to FIG. 12, the auxiliary tuning volume 102 is optimized empirically and/or analytically in relation to the air intake housing 100, airflow demand and intake noise generation of the associated engine, as well as the primary sound attenuator 130 of the air intake housing 100 in order to amplify the sound attenuation and broaden the bandwidth of the sound attenuation of the primary sound attenuator.

As a general rule of thumb, the tuning chamber may have a volume in the neighborhood of about 0.5 L, but his depends on the environment of operation of the auxiliary tuning volume 102. By way of example, and not limitation, with respect to FIGS. 2 through 5, the tuning chamber 116 has a volume of about 616069.8 mm³, the tuning slot 112 has an area of about 6552 mm², defined by a length L of about 157.14 mm and a width W of about 41.67 mm, wherein the air flow passage 114 has a volume of about 4127799.7 mm³, and the primary Helmholtz attenuator 132 has a primary Helmholtz chamber 134 having a volume of about 411691.3 mm³ and an opening having an area of about 2392.23 mm².

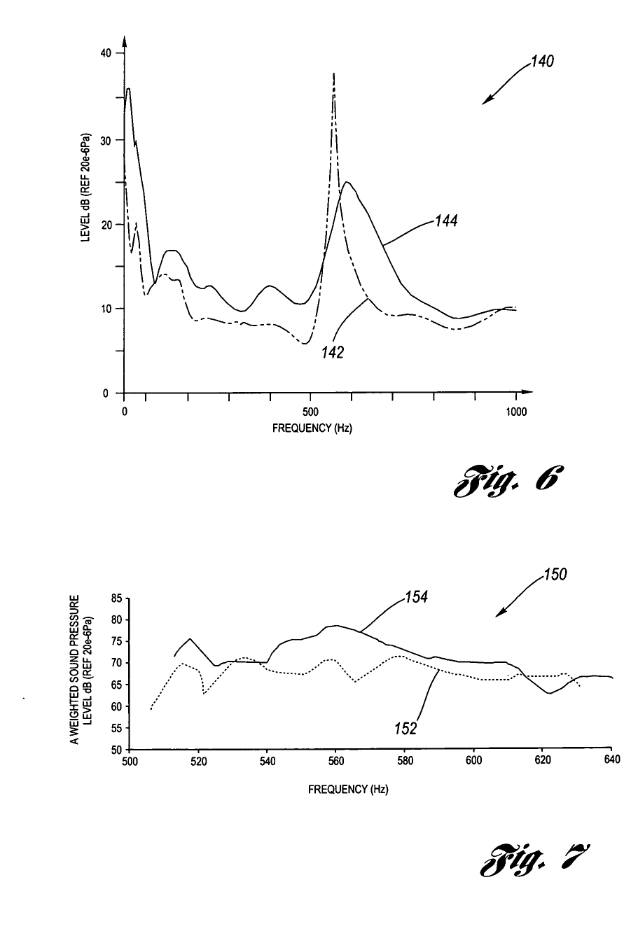

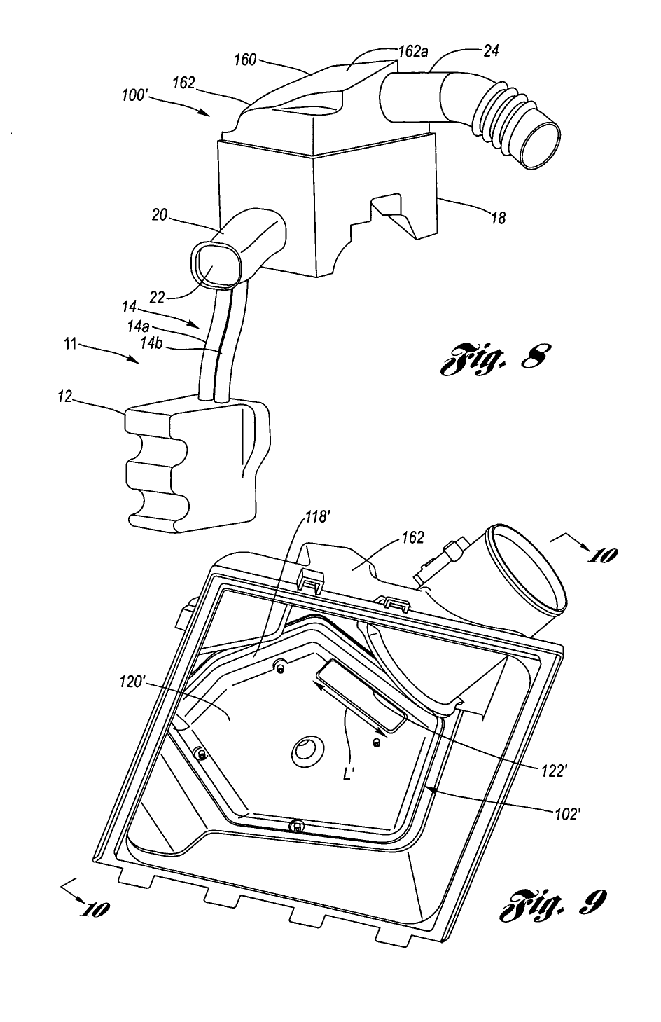

The auxiliary tuning 102 according to the present invention provides enhancement of the attenuation of the primary sound attenuator 130 (i.e., the primary Helmholtz attenuator 132), while additionally broadening the bandwidth (frequency spectrum) of the sound attenuation thereof. This result is exemplified in the graphical representations of FIGS. 6 and 7.

FIG. 6 is a graph 140 of frequency of sound versus sound level, wherein a first plot 142 is for an air induction housing 100 having a primary 600 Hz Helmholtz attenuator 132 and the auxiliary tuning volume 102, as depicted at FIG. 2, and a second plot 144 is for an air induction housing similar to that of FIG. 2, having the primary 600 Hz Helmholtz attenuator, but not including the auxiliary tuning volume of the present invention. It will be seen that plot 142 has a much broader bandwidth (frequency range) than that of plot 144, which broadening can be tuned based upon selection of tuning chamber 116 volume and tuning slot 112 dimension selection.

FIG. 7 is a graph 150 of frequency of sound versus sound level, wherein a first plot 152 is for an air induction housing 100 having a primary 600 Hz Helmholtz attenuator 132 and the auxiliary tuning volume 102, as depicted at FIG. 2, and a second plot 154 is a baseline for an air induction housing similar to that of FIG. 2, having the primary 600 Hz Helmholtz attenuator, but not including the auxiliary tuning volume of the present invention. It will be seen that plot 152 has better sound (i.e., supercharger noise) attenuation than that of plot 154 over a broad bandwidth.

Turning attention now to FIGS. 8, 9 and 10, the air intake housing 100′ is modified from the air intake housing 10 of FIG. 1 to now include an auxiliary tuning volume 102′ according to the present invention.

The description of the air intake housing 100′ is the same for all aspects of the lower housing component 18, as depicted at FIG. 1 (all numbers associated therewith carrying over to FIG. 8) wherein the Helmholtz attenuator 11 is now the primary sound attenuator as used in the present invention. However, the upper housing component 16 of FIG. 1 is modified as per the upper housing component 160 of FIGS. 8, 9 and 10.

The upper housing component 160 is defined by an upper sidewall 162 having an upper wall 162a. The auxiliary tuning volume 102′ according to the present invention is mounted (as for example by any suitable plastic welding technique) to the upper wall 162a internally to the upper housing component 160. The auxiliary tuning volume 102′ is in the form of a tuning chamber 116′, defined by a chamber sidewall 118′ which includes an intermediate wall 120′ whereby the tuning chamber is separated from the main airflow passage 114′. A tuning slot 122′ is formed in the intermediate wall 120′ which permits air borne sound communication between the tuning chamber 116′ and the main airflow passage 114′. The tuning slot 118′ has a longest elongation length L′ which is oriented transversely in relation to the direction of the airflow A′ though the main airflow passage 114′. In this regard, it is preferred for the tuning slot to be located at a downstream end 116a′ of the tuning chamber 116′, whereby sound entering thereinto through the tuning slot 112′ is caused to travel toward the upstream end 116b′ of the tuning chamber (the end closest to the air intake opening 22 of FIG. 8).

It is to be understood that the auxiliary tuning volume 102′ of the upper housing component 160 may be utilized with other configured lower housing components having different types of primary sound attenuators, as for example those disclosed in U.S. patent application Ser. No. 11/681,286, filed on Mar. 2, 2007, Ser. No. 12/057,401, filed on Mar. 28, 2008, both to Julie Ann Koss, the disclosures of which are hereby herein incorporated by reference. The volume of the tuning chamber 116′ and the area of the tuning slot 112′ are optimized per the associated intake housing, airflow rate, engine (per its airflow requirements and intake noise generation), and type of primary sound attenuator, as per the discussion hereinbelow with respect to FIG. 12.

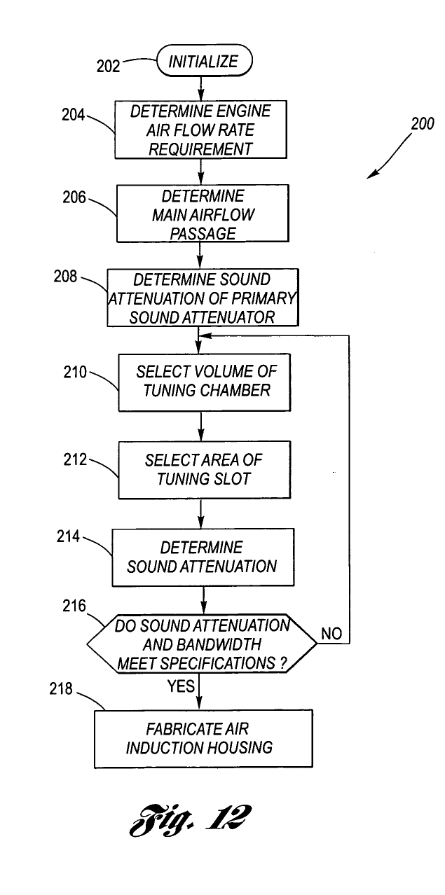

FIG. 11 is a graph 170 of engine RPM versus sound level, wherein a first plot 172 is for an air induction housing 10 as in FIG. 1 having a snorkel and Helmholtz chamber (having an inlet extension, ¼ wave, primary Helmholtz attenuator), a second plot 174 is for an air induction housing 100′ as in FIG. 8 (having an inlet extension, ¼ wave, primary Helmholtz attenuator), which includes an auxiliary tuning volume 102′ (of 1.5 L total volume), and a third plot 176 is for a predetermined acceptable quietness level. It is seen that plot 174 clearly provides sound attenuation much better than plot 172, indeed well below the baseline of plot 176 over the indicated range of engine RPM.

Turning attention now to FIG. 12, depicted is an example of an algorithm for tuning the auxiliary tuning volume according to the present invention whereby, for any primary sound attenuator of the air induction housing, the auxiliary tuning volume is tuned to optimize the attenuation enhancement and the bandwidth broadening for the primary sound attenuator. While the description below, by way of example, is based upon FIGS. 2 through 5, it is to be understood that the description is generally applicable to an air induction housing as used for example, but not limitation, supplying intake air to normally aspirated or charged internal combustion engines, hydrogen fuel cells, etc.

At Block 202, the algorithm is initialized. At Block 204, the engine airflow rate requirement of a selected internal combustion engine is determined. At Block 206, the necessary airflow passage is determined such that back pressure is not an issue for the operation of the internal combustion engine, which determination includes any packaging constraints of the engine compartment. At Block 208, a primary sound attenuator is determined, and the sound (acoustic) attenuation performance is selected, for example, with respect to the engine and the air intake housing, taking into further account engine intake noise over a selected range of engine RPM.

Next, at Blocks 210 and 212, an auxiliary tuning volume configuration is selected, based mainly upon the tuning chamber volume selection and tuning slot area selection, taking into account any engine compartment packaging constraints. At Block 214, determined are the enhancement of attenuation of the primary sound attenuator provided by the auxiliary Helmholtz attenuator, as well as the broadening of the bandwidth of the sound attenuation of the primary sound attenuator as provided by the auxiliary tuning volume.

At Decision Block 216, inquiry is made whether the attenuation and bandwidth performance of the auxiliary tuning volume at Block 214 meets predetermined quietness specifications, wherein, if the answer to the inquiry is yes, the optimization is complete and fabrication of the air induction housing with the auxiliary tuning volume may proceed; otherwise, if the answer to the inquiry is no, then the algorithm loops back to Block 210 for further optimization processing as described above.

To those skilled in the art to which this invention appertains, the above described preferred embodiment may be subject to change or modification. Such change or modification can be carried out without departing from the scope of the invention, which is intended to be limited only by the scope of the appended claims.

1. An air induction housing providing sound attenuation of air intake noise, comprising:
a housing having a predetermined main airflow passage defined by a housing sidewall;
a primary attenuator connected with said housing sidewall, said primary sound attenuator providing a predetermined intake noise sound attenuation over a predetermined bandwidth;
an auxiliary tuning volume connected to said housing sidewall, said auxiliary tuning volume comprising: and
a tuning chamber; and
an intermediate wall disposed between said main airflow passage and said tuning chamber, said intermediate wall having formed therein a tuning slot, wherein said tuning slot provides air borne sound communication between said main airflow passage and said tuning chamber;
wherein said auxiliary tuning volume provides enhancement of the sound attenuation of said primary sound attenuator, and said auxiliary tuning volume provides broadening of the bandwidth of sound attenuation of said primary sound attenuator.

2. The air induction housing of claim 1, wherein airflow through said main airflow passage is in a predetermined airflow direction; and wherein said tuning slot has a length and a width, said length being longer than said width, wherein said length is oriented transversely in relation to said airflow direction.

3. The air intake housing of claim 2, wherein said airflow direction defines a downstream end of said tuning chamber, wherein said tuning slot is disposed substantially adjacent said downstream end.

4. The air intake housing of claim 3, wherein said air intake housing has an upper portion, wherein said auxiliary tuning volume is disposed at said upper portion.

5. An air induction housing providing sound attenuation of air intake noise, comprising:
a housing having a predetermined main airflow passage defined by a housing sidewall;
a primary sound attenuator connected to said air intake housing sidewall, said primary sound attenuator providing a predetermined intake noise sound attenuation over a predetermined bandwidth; and
an auxiliary tuning volume connected with said housing sidewall, said auxiliary tuning volume comprising:
a tuning chamber; and
an intermediate wall disposed between said main airflow passage and said Helmholtz chamber, said intermediate wall having formed therein a tuning slot having a length and a width, said length being longer than said width, wherein said tuning slot provides air borne sound communication between said main airflow passage and said tuning chamber;
wherein said auxiliary tuning volume provides enhancement of the sound attenuation of said primary sound attenuator, and further provides broadening of the bandwidth of sound attenuation of said primary sound attenuator; and
wherein airflow through said main airflow passage is in a predetermined airflow direction; and wherein said length of said tuning slot is oriented transversely in relation to said airflow direction.

6. The air intake housing of claim 5, wherein said airflow direction defines a downstream end of said tuning chamber, wherein said tuning slot is disposed substantially adjacent said downstream end.

7. The air intake housing of claim 6, wherein said air intake housing has an upper portion, wherein said auxiliary tuning volume is disposed at said upper portion.

8. A method for enhancing sound attenuation and broadening the bandwidth of the sound attenuation of a primary sound attenuator of an air intake housing, comprising the steps of:
determining intake airflow and intake noise of an engine over a predetermined range of RPM;
determining an air induction housing;
determining a primary sound attenuator connected to said air induction housing, wherein the primary sound attenuator provides a predetermined sound attenuation of the intake noise over a predetermined bandwidth;
selecting an auxiliary tuning volume connected to the air intake housing so as to communicate through a tuning slot with air borne sound of airflow in the air induction housing, wherein the auxiliary tuning volume has a tuning chamber which interacts with the intake noise through the tuning slot such that the auxiliary tuning volume enhances the sound attenuation of the primary sound attenuator and further broadens the bandwidth of the attenuation; and
fabricating the determined intake housing with the determined primary sound attenuator and the selected auxiliary tuning volume.

9. An air induction housing including a primary sound attenuator and an auxiliary tuning volume made according to the method of claim 8.

10. The method of claim 8, wherein said step of providing further comprises tuning the auxiliary tuning volume so as to optimize the enhancement of the sound attenuation and broadening of the bandwidth of the attenuation.

11. The method of claim 10, wherein said step of tuning comprises:
selection of volume of the tuning chamber; and
selection of area of the tuning slot.

12. The method of claim 11, wherein said step of tuning further comprises:
selecting the tuning slot such that it has a length and width, the length exceeding the width, wherein the length is oriented transversely in relation to a predetermined direction of airflow through the air intake housing adjacent the tuning slot.
